(19) United States
(12) Patent Application Publication
(10) Pub. No.: US 2020/0021160 A1
(43) Pub. Date: Jan. 16, 2020

(54) MOTOR AND PUMP DEVICE

(71) Applicant: NIDEC SANKYO CORPORATION, Nagano (JP)

(72) Inventors: Hiroki KURATANI, Nagano (JP); Takashi YAMAMOTO, Nagano (JP); Nobuki KOKUBO, Nagano (JP); Masaki HARADA, Nagano (JP)

(21) Appl. No.: 16/485,933

(22) PCT Filed: Feb. 7, 2018
(86) PCT No.: PCT/JP2018/004141

§ 371 Date: Aug. 14, 2019

(30) Foreign Application Priority Data
Feb. 14, 2017 (JP) 2017-024969

(51) Int. Cl. H02K 3/52; H02K 3/44; H02K 5/22; H02K 7/14; F04D 25/06

(52) U.S. Cl. CPC H02K 3/522; H02K 3/44; F04D 25/06; H02K 7/14; H02K 5/225

(57) ABSTRACT

A motor may include a rotor; and a stator arranged on an outer peripheral side of the rotor. The stator may include a stator core, a plurality of insulators covering the stator core, a coil wound around the stator core through each of the insulators, and a common wire formed of a conductive wire drawn from the coil. At least one of the plurality of insulators includes a first common wire support portion configured to support the common wire from an outside in a radial direction. The first common wire support portion extends inward in the radial direction toward a tip end side of the common wire.

### CROSS REFERENCE TO RELATED APPLICATIONS

This is the U.S. national stage of application No. PCT/JP2018/004141, filed on Feb. 7, 2018. Priority under 35 U.S.C. § 119(a) and 35 U.S.C. § 365(b) is claimed from Japanese Application No. 2017-024969, filed Feb. 14, 2017; the disclosures of which are incorporated herein by reference.

### TECHNICAL FIELD

At least an embodiment of the present invention relates to a pump device and a motor used for the pump device.

### BACKGROUND

Patent Literature 1 discloses a pump device configured to rotate an impeller by a motor. The motor used for the pump device of Patent Literature 1 includes a rotor and a stator arranged on an outer peripheral side of the rotor, and the stator is covered with a resin sealing member and sealed. The stator includes a stator core, an insulator, and a coil wire wound around the insulator.

Patent Literature 2 discloses a motor configured such that conductive wires forming coils are in star connection to form a common wire. In the motor of Patent Literature 2, when a circuit board is fixed to an insulator, the common wire is housed between the insulator and the circuit board. Alternatively, when a cap member is attached to cover the circuit board, the common wire is housed between the cap member and the circuit board or the insulator. This ensures insulation of the common wire.

### CITATION LIST

[Patent Literature 1] Japanese Unexamined Patent Application Publication No. 2016-3580
[Patent Literature 2] Japanese Unexamined Patent Application Publication No. 2012-135188

In the motor described in Patent Literature 2, another member such as the circuit board or the cap needs to be assembled to the insulator to hold the common wire and ensure insulation. On the other hand, when the structure in which the stator is covered with the resin sealing member as in Patent Literature 1 is employed, the resin sealing member can ensure insulation of the common wire. However, Patent Literature 1 does not describe the method of holding the common wire such that the common wire does not protrude from the resin sealing member when the resin sealing member is formed. In particular, the method of holding the common wire such that the common wire does not protrude to an outer peripheral side of the stator without using another member such as the circuit board at a stage before the stator is integrally formed with the resin sealing member is not described.

Typically, the method of pushing the common wire into a gap between coils adjacent to each other in the circumferential direction is also used as the method of holding the common wire, but a gap needs to be provided between the coils. Further, there is also the method of fixing the common wire to the stator with an adhesive. However, adhesive curing time is needed, and for this reason, productivity is low.

In view of the above-described problems, at least an embodiment of the present invention holds a common wire such that the common wire does not protrude to an outer peripheral side of a stator.

For solving the above-described problems, the motor of at least an embodiment of the present invention includes a rotor and a stator arranged on an outer peripheral side of the rotor. The stator includes a stator core, a plurality of insulators covering the stator core, a coil wound around the stator core through each of the insulators, and a common wire formed of a conductive wire drawn from the coil. At least one of the plurality of insulators includes a first common wire support portion configured to support the common wire from the outside in a radial direction. The first common wire support portion is in a shape extending inward in the radial direction toward a tip end side of the common wire.

In the motor of at least an embodiment of the present invention, the insulator is provided with the first common wire support portion configured to support the common wire from the outside in the radial direction. The first common wire support portion is in the shape extending inward in the radial direction toward the tip end side of the common wire, and therefore, protrusion of the common wire to the outer peripheral side of the first common wire support portion can be suppressed. Thus, exposure of the common wire to the outer peripheral side of the stator can be suppressed.

As described above, the motor of at least an embodiment of the present invention is configured so that the common wire can be temporarily fixed to the insulator with the common wire being supported by the first common wire support portion. Thus, for example, in the case of sealing the stator with the resin sealing member, the common wire can be held so as not to protrude to the outside of the resin sealing member. Thus, the common wire can be insulated. Further, the first common wire support portion is integrally formed with the insulator, and therefore, another component for suppressing protrusion of the common wire is not necessarily used. Thus, an increase in the number of components can be suppressed.

In at least an embodiment of the present invention, the insulator provided with the first common wire support portion preferably includes a second common wire support portion connected to an end portion of the first common wire support portion, the end portion being on an inner side in the radial direction. With this configuration, a tip end portion of the common wire can be supported by the second common wire support portion. Thus, exposure of the common wire to the outer peripheral side of the stator can be suppressed.

At least an embodiment of the present invention preferably includes a resin sealing member configured to cover the stator. The resin sealing member is preferably provided with a plurality of holes as arrangement marks of pressing members configured to press the stator against a mold for forming the resin sealing member. The second common wire support portion is preferably arranged in an angular range including an angular position of any of the plurality of holes. With this configuration, the common wire can be supported so as not to protrude to the pressing member side, and contact between each of the pressing members and the common wire can be prevented. Thus, disconnection of the common wire due to the common wire being caught between the pressing member and the insulator can be prevented.

In at least an embodiment of the present invention, one of the plurality of insulators is preferably connected to a connector, the insulator adjacent, in a circumferential direction, to the insulator connected to the connector preferably includes a conductive wire guide portion configured to guide a conductive wire drawn from the coil to the connector, and the conductive wire guide portion is preferably arranged in an angular range including an angular position of any of the plurality of holes. With this configuration, the conductive wire can be supported so as not to protrude to the pressing member side, and contact between each of the pressing members and the conductive wire can be prevented. Thus, disconnection of the conductive wire due to the conductive wire being caught between the pressing member and the insulator can be prevented.

In at least an embodiment of the present invention, at least one of the insulators adjacent, in the circumferential direction, to the insulator provided with the first common wire support portion preferably includes a common wire guide portion configured to guide the common wire. With this configuration, the common wire can be easily drawn toward the first common wire support portion.

In at least an embodiment of the present invention, the first common wire support portion is preferably provided at a single location on each end side of the insulator in the circumferential direction. This configuration can be applied regardless of whether the direction of drawing the common wire is a first side or a second side in the circumferential direction.

In at least an embodiment of the present invention, each of the insulators preferably includes a jumper wire guide portion configured to guide a jumper wire connecting the coils of an identical phase. With this configuration, the jumper wire can be drawn in an appropriate path.

In this case, each of the insulators is preferably provided with the jumper wire guide portion at two locations spaced apart in the circumferential direction, and each jumper wire preferably includes a pushed portion pushed into a gap between the jumper wire guide portions at the two locations. With this configuration, looseness of the jumper wire can be suppressed, whereby expansion of the jumper wire to the outer peripheral side can be suppressed.

Next, a pump device of at least an embodiment of the present invention includes the above-described motor, an impeller attached to a rotating shaft of the rotor, and a pump chamber in which the impeller is arranged.

According to at least an embodiment of the present invention, the insulator is provided with the first common wire support portion configured to support the common wire from the outside in the radial direction. The first common wire support portion is in the shape extending inward in the radial direction toward the tip end side of the common wire, and therefore, protrusion of the common wire to the outer peripheral side of the first common wire support portion can be suppressed. Thus, exposure of the common wire to the outer peripheral side of the stator can be suppressed.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is an external perspective view of a pump device to which at least an embodiment of the present invention is applied.

FIG. 2A and FIG. 2B are a cross-sectional view and a partially-enlarged view of the pump device.

FIG. 3 is an exploded perspective view of a motor as viewed from an output side.

FIG. 4 is an exploded perspective view of the motor as viewed from an opposite-output side.

FIG. 5 is a perspective view of a stator as viewed from the output side.

FIG. 6 is a perspective view of the stator as viewed from the opposite-output side.

FIG. 7 is a plan view of the stator as viewed from the output side.

FIG. 8 is a plan view of the stator as viewed from the opposite-output side.

FIG. 9 is a cross-sectional view of a connector and an insulator.

### DETAILED DESCRIPTION

Hereinafter, an embodiment of a pump device and a motor to which at least an embodiment of the present invention is applied will be described with reference to the drawings.

### (Entire Configuration of Pump Device)

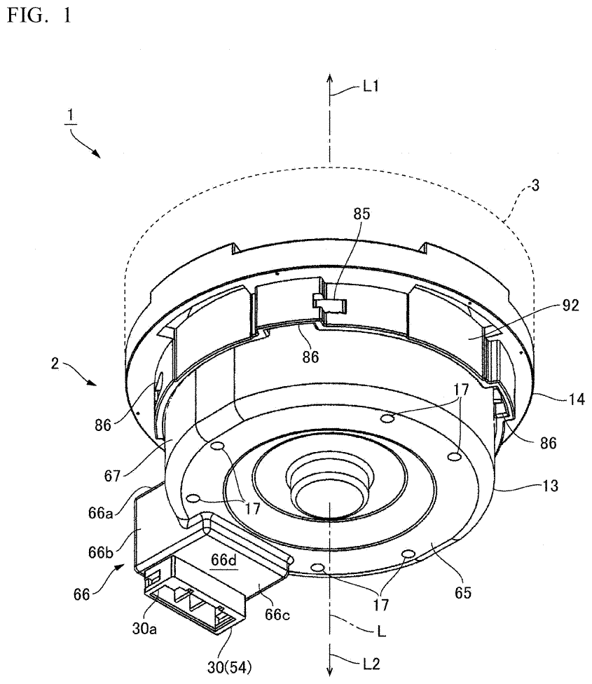

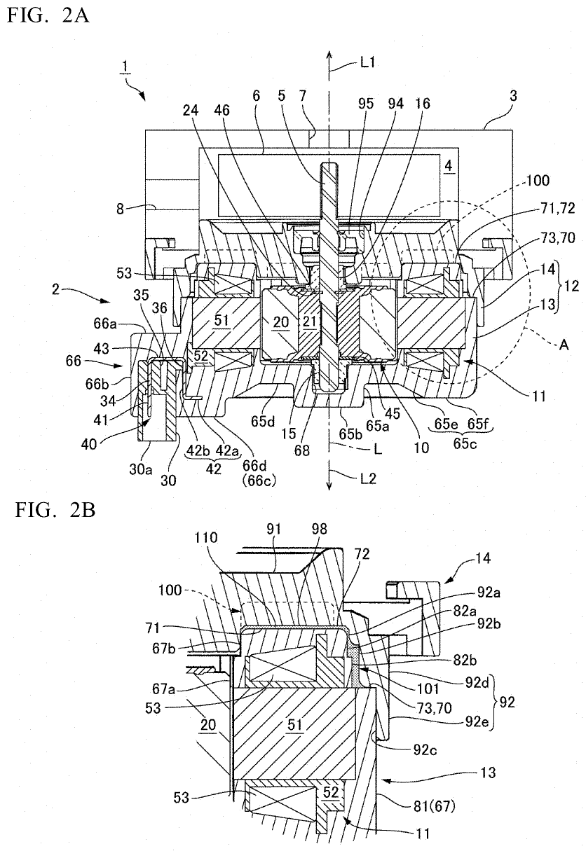

FIG. 1 is an external perspective view of a pump device 1 to which at least an embodiment of the present invention is applied. Moreover, FIG. 2A is a cross-sectional view of the pump device 1, and FIG. 2B is a partially-enlarged view of a region A of FIG. 2A. The pump device 1 includes a motor 2, a case body 3 attached to the motor 2 and forming a pump chamber 4 between the motor 2 and the case body 3, and an impeller 6 attached to a rotating shaft 5 of the motor 2 and arranged in the pump chamber 4. The case body 3 is provided with a suction port 7 and a discharge port 8 for fluid. When the motor 2 is driven to rotate the impeller 6, fluid such as water sucked from the suction port 7 is discharged from the discharge port 8 through the pump chamber 4.

In the present Description, a reference symbol L indicates an axial direction of the motor 2, an output side L1 is a first side in the direction of an axis L, and an opposite-output side L2 is a second side in the direction of the axis L. FIG. 1 is an external perspective view of the pump device 1 as viewed from the opposite-output side L2. The rotating shaft 5 of the motor 2 extends in the direction of the axis L. Moreover, the side on which the impeller 6 is arranged with respect to the motor 2 is the output side L1, and an opposite side to the output side L1 is the opposite-output side L2. Further, a direction orthogonal to the axis L is taken as a radial direction, and a direction about the axis L is taken as a circumferential direction. As shown in FIG. 2A and FIG. 2B, the suction port 7 is provided at a position overlapping with the axis L of the rotating shaft 5 of the motor 2 in the case body 3, and the discharge port 8 is provided on the outside of the rotating shaft 5 in the radial direction.

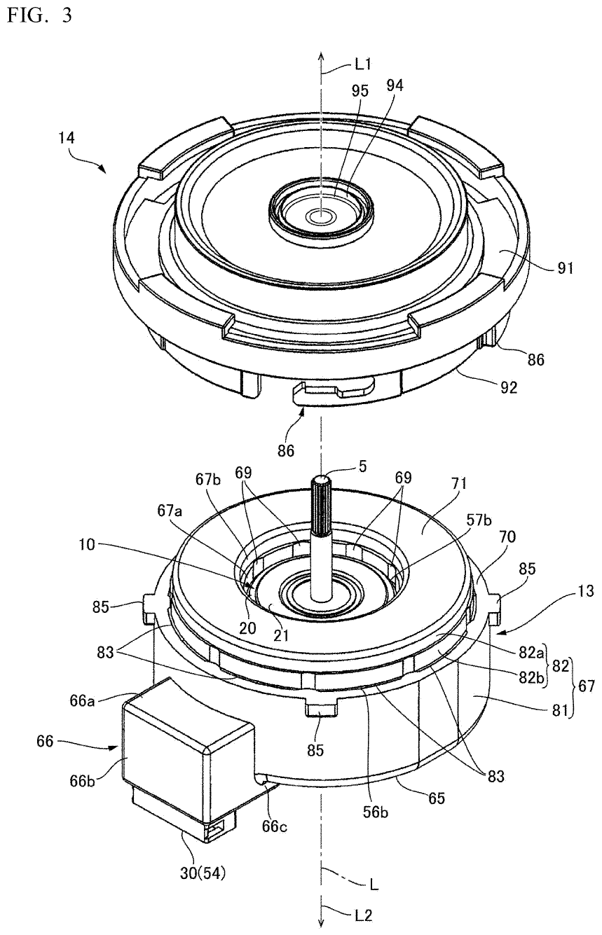

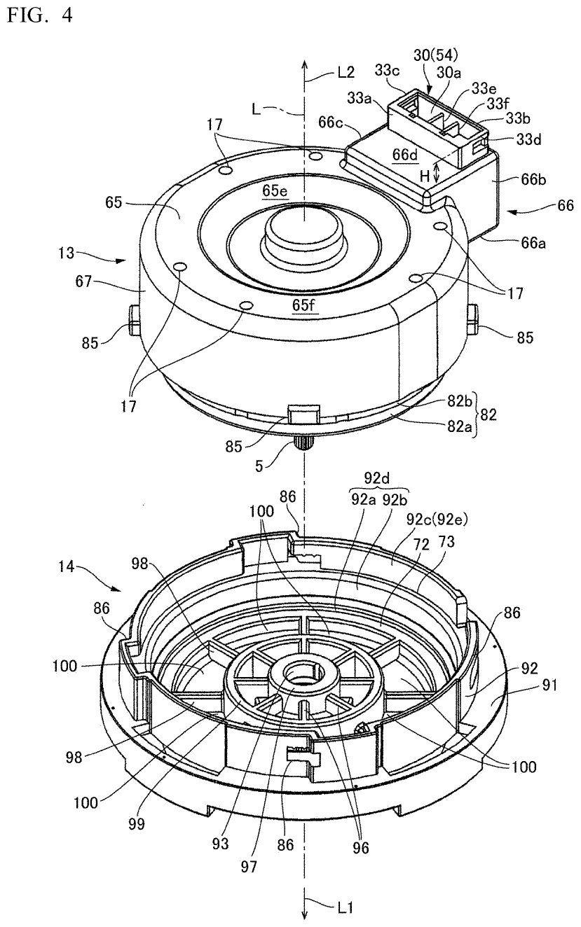

FIG. 3 is an exploded perspective view of the motor 2 as viewed from the output side L1, and FIG. 4 is an exploded perspective view of the motor as viewed from the opposite-output side L2. FIG. 3 and FIG. 4 show a state in which a cover member 14 forming a housing 12 of the motor 2 is detached from a resin sealing member 13. The motor 2 is a DC brushless motor, and includes a rotor 10, a stator 11, and a housing 12 for housing these components. The housing 12 includes the resin sealing member 13 covering the stator 11 from the opposite-output side L2, and the cover member 14 covering the resin sealing member 13 from the output side L1. The cover member 14 is fixed to the resin sealing member 13.

The case body 3 is placed on the cover member 14 from the output side L1. Thus, a space partitioned between the cover member 14 and the case body 3 serves as the pump chamber 4. The resin sealing member 13 holds a first bearing member 15 configured to rotatably support an end portion of the rotating shaft 5 of the rotor 10 on the opposite-output side L2. The cover member 14 holds a second bearing member 16 configured to rotatably support a middle portion of the rotating shaft 5. An end portion of the rotating shaft 5 on the output side L1 protrudes from the housing 12 of the motor 2 into the pump chamber 4, and is attached with the impeller 6.

### (Rotor)

As shown in FIG. 2A and FIG. 2B, the rotor 10 includes the rotating shaft 5, a magnet 20 surrounding the rotating shaft 5, and a holding member 21 configured to hold the rotating shaft 5 and the magnet 20. The magnet 20 is in an annular shape, and is arranged coaxially with the rotating shaft 5. An outer peripheral surface of the magnet 20 is alternately magnetized to N-poles and S-poles in the circumferential direction. The rotating shaft 5 is made of stainless steel. The rotating shaft 5 has an annular groove formed near the center in the direction of the axis L, and an E-ring 24 is fixed to the annular groove. The E-ring 24 is a plate-shaped member made of metal. The E-ring 24 is embedded in an end surface of the holding member 21 on the output side L1.

The rotor 10 includes a first bearing plate 45 arranged on the opposite-output side L2 of the holding member 21, and a second bearing plate 46 arranged on the output side L1 of the holding member 21. The first bearing plate 45 and the second bearing plate 46 are substantially circular ring-shaped metal plates. For example, the first bearing plate 45 and the second bearing plate 46 are metal washers. The first bearing plate 45 covers an end surface of the holding member 21 on the opposite-output side L2 in a state in which the rotating shaft 5 penetrates a center hole of the first bearing plate 45. Further, the second bearing plate 46 covers an end surface of the holding member 21 on the output side L1 and the E-ring 24 in a state in which the rotating shaft 5 penetrates a center hole of the second bearing plate 46. The second bearing plate 46 makes surface contact with the E-ring 24. The first bearing plate 45 and the second bearing plate 46 are respectively held by the end surface of the holding member 21 on the opposite-output side L2 and the end surface of the holding member 21 on the output side L1. Sliding heat generated by sliding of the second bearing plate 46 and the second bearing member 16 during rotation of the rotor 10 is transmitted to the rotating shaft 5 through the E-ring 24, and is dissipated.

### (Stator)

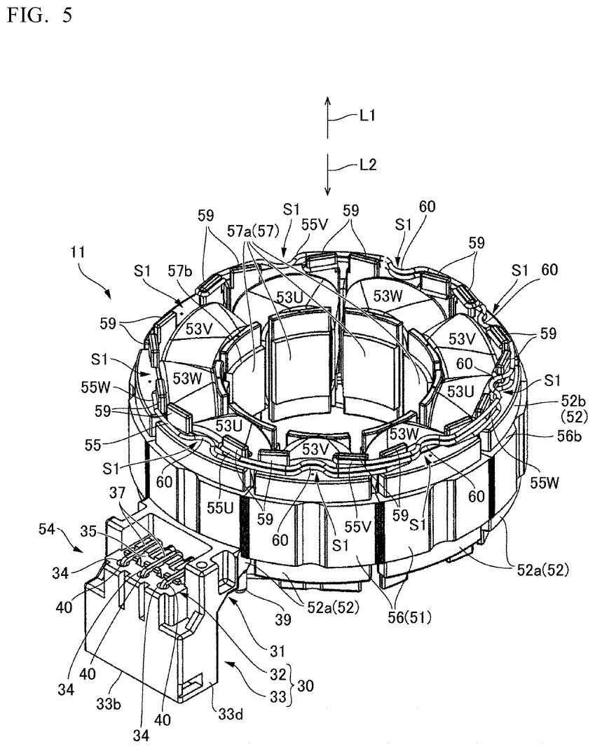

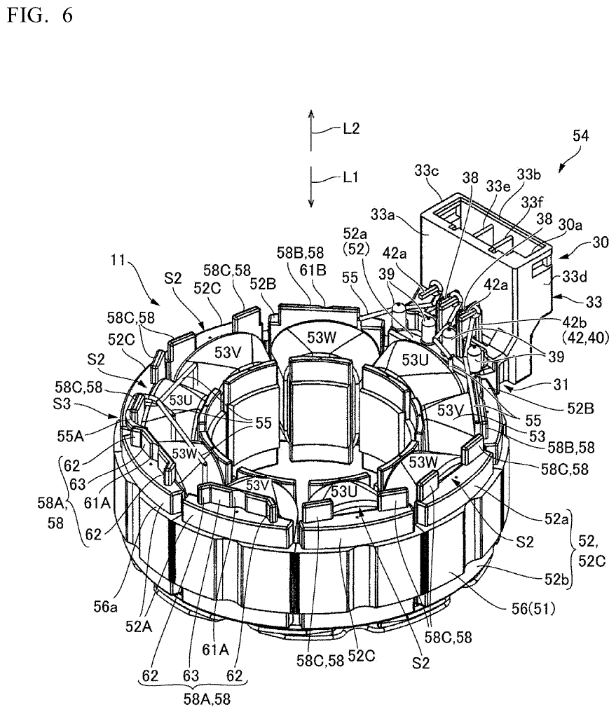

FIG. 5 and FIG. 6 are perspective views of the stator 11. FIG. 5 is a perspective view as viewed from the output side L1, and FIG. 6 is a perspective view as viewed from the opposite-output side L2. The stator 11 includes an annular stator core 51 located on an outer peripheral side of the rotor 10, a plurality of coils 53 wound around the stator core 51 through insulators 52, and a connector 54 configured to connect a feeding line for feeding power to each of the coils 53.

The stator core 51 is a laminated core formed by laminating thin magnetic plates made of a magnetic material. As shown in FIG. 5 and FIG. 6, the stator core 51 includes an annular portion 56 and a plurality of salient pole portions 57 protruding inward in the radial direction from the annular portion 56. The plurality of salient pole portions 57 are formed at equal angle pitches, and are arranged at constant pitches in the circumferential direction. An inner peripheral end surface 57a of each of the salient pole portions 57 is an arc surface with the axis L as the center thereof. The inner peripheral end surface 57a of the salient pole portion 57 faces an outer peripheral surface of the magnet 20 of the rotor 10 with a slight gap interposed therebetween.

The insulator 52 is made of an insulating material such as resin. The insulator 52 is in a flanged tubular shape having flange portions at both ends in the radial direction. The insulator 52 is attached to each of the plurality of salient pole portions 57. The coil 53 is wound around each of the plurality of salient pole portions 57 through the insulator 52. The insulator 52 partially covers an opposite-output-side end surface 56a (see FIG. 6) of the annular portion 56 of the stator core 51, but an outer peripheral edge section of the opposite-output side end surface 56a is not covered with the insulator 52. Similarly, the insulator 52 partially covers an output-side end surface 56b (see FIG. 5) of the annular portion 56 of the stator core 51, but an outer peripheral edge section of the output-side end surface 56b is not covered with the insulator 52.

The coil 53 is formed of a conductive wire 55 made of aluminum alloy or copper alloy. In the present embodiment, a conductive wire 55, in which aluminum alloy is covered with copper alloy, is used. Further, in the present embodiment, the number of salient pole portions 57, the number of insulators 52 and the number of coils 53 are each nine. The motor 2 is a three-phase brushless motor. Three of nine coils 53 are U-phase coils 53U, three of the remaining six coils 53 are V-phase coils 53V, and the remaining three coils 53 are W-phase coils 53W. The U-phase coils 53U, the V-phase coils 53V, and the W-phase coils 53W are arranged in this order in the circumferential direction. Note that other arrangements may be employed.

Three U-phase coils 53U are formed by sequentially winding the single conductive wire 55 around three salient pole portions 57. Three V-phase coils 53V are formed by sequentially winding the single conductive wire 55 around three salient pole portions 57. Three W-phase coils 53W are formed by sequentially winding the single conductive wire 55 around three salient pole portions 57. Three conductive wires 55 forming the U-phase coils 53U, the V-phase coils 53V, and the W-phase coils 53W are drawn to the connector 54. The U-phase coils 53U, the V-phase coils 53V, and the W-phase coils 53W are respectively connected to the connector 54 through the conductive wire 55.

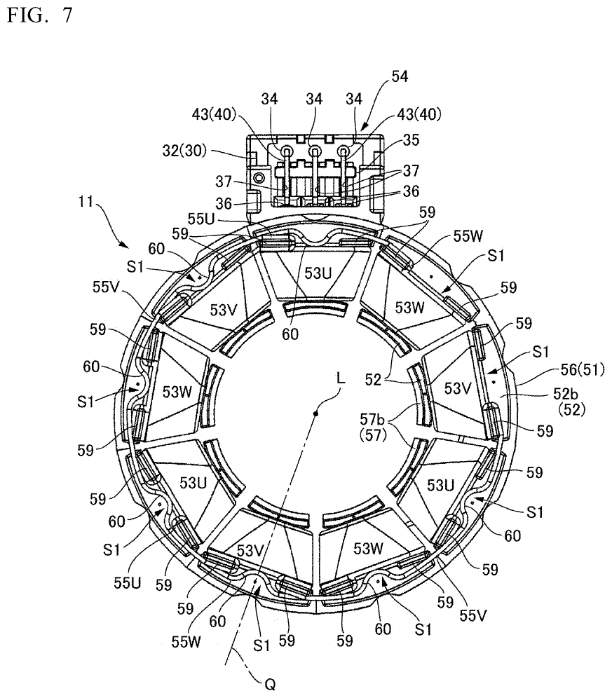

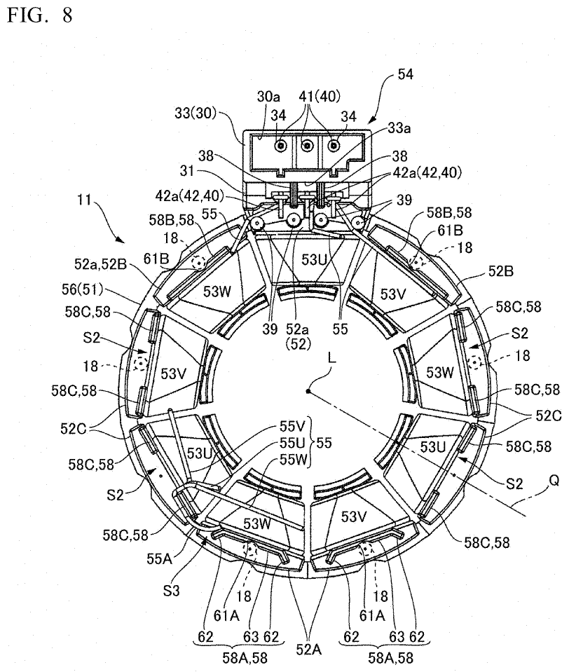

FIG. 7 and FIG. 8 are plan views of the stator 11. FIG. 7 is the plan view as viewed from the output side L1, and FIG. 8 is the plan view as viewed from the opposite-output side L2. As shown in FIG. 5 to FIG. 8, the insulator 52 includes core outer side surface covering portions 52a, 52b covering end surfaces of the stator core 51 in the direction of the axis L on an outer peripheral side of the coil 53. The core outer side surface covering portion 52a partially covers the opposite-output side end surface 56a of the annular portion 56 of the stator core 51. On the other hand, the core outer side surface covering portion 52b partially covers the output-side end surface 56b of the annular portion 56 of the stator core 51. The connector 54 is arranged on an outer peripheral side of the core outer side surface covering portion 52a, and is connected to the core outer side surface covering portion 52a.

Inner peripheral edges of the core outer side surface covering portions 52a, 52b are in a linear shape orthogonal to a center line Q (see FIG. 7 and FIG. 8) of the insulator 52 in the circumferential direction. Although FIG. 7 and FIG. 8 show the center line Q only at a single location, a straight line passing through the center of each of the insulators 52 in the circumferential direction will be referred to as a center line Q. As shown in FIG. 6 and FIG. 8, wall portions 58 as protruding portions protruding toward the opposite-output side L2 along the inner peripheral edge of the core outer side surface covering portion 52a are formed at eight insulators 52 other than the insulator 52 provided at the same angle position as that of the connector 54. Moreover, as shown in FIG. 5 and FIG. 7, a wall portion 59 as a protruding portion protruding toward the output side L1 along the inner peripheral edge of the core outer side surface covering portion 52b is formed at each of nine insulators 52. On the opposite-output side L2 of the stator 11, the conductive wires 55 and a common wire 55A are guided by the wall portions 58. Further, on the output side L1 of the stator 11, the conductive wires 55 (jumper wires 55U, 55V, 55W) are guided by the wall portions 59.

### (Jumper Wire Guide Portion)

As shown in FIG. 5 and FIG. 7, the wall portions 59 of the present embodiment are formed at both ends of the inner peripheral edge of the core outer side surface covering portion 52b in the circumferential direction at each of nine insulators 52. The wall portion 59 is in the form of a flat plate orthogonal to the center line Q, in the circumferential direction, of the insulator 52 provided with the wall portion 59. That is, each of nine insulators 52 includes two wall portions 59 spaced apart in the circumferential direction, and also includes a gap S1 formed between these two wall portions 59. Two wall portions 59 formed at each of the insulators 52 are located on the same plane, and have the same shape.

As shown in FIG. 5 and FIG. 7, on the outer peripheral side of the coil 53, the jumper wire 55U, the jumper wire 55V, and the jumper wire 55W connecting the coils 53 of the same phase are guided and drawn by the wall portions 59. The jumper wire 55U is a conductive wire 55 connecting the U-phase coils 53U, the jumper wire 55V is a conductive wire 55 connecting the V-phase coils 53V, and the jumper wire 55W is a conductive wire 55 connecting the W-phase coils 53W. At each of the insulators 52, the wall portions 59 functioning as jumper wire guide portions configured to guide the jumper wires 55U, 55V, 55W are provided at two locations spaced apart in the circumferential direction.

For example, the jumper wire 55U extending over one U-phase coil 53U and another U-phase coil 53U is drawn to the outer peripheral side from the gap S1 provided at the insulator 52 around which the U-phase coil 53U is wound, is hooked on one (for example, the wall portion 59 on the side of the adjacent V-phase coil 53V) of two wall portions 59, and is drawn to the side of the adjacent insulator 52 on the outside of the wall portion 59 in the radial direction. Then, the jumper wire 55U is guided by four wall portions 59 provided at two insulators 52 provided with the V-phase coil 53V and the W-phase coil 53W, and is drawn to the insulator 52 provided with the other U-phase coil 53U. Then, the jumper wire 55U is hooked on the wall portion 59 (for example, the wall portion 59 on the side of the W-phase coil 53W) provided on the insulator 52 provided with the other U-phase coil 53U, and is drawn from the gap S1 to the side of the U-phase coil 53U.

A pushed portion 60 formed in such a manner that the conductive wire 55 is pushed to an inner peripheral side of the wall portion 59 is formed at the jumper wire 55U extending between one U-phase coil 53U and another U-phase coil 53U. As described above, two wall portions 59 spaced apart in the circumferential direction are provided at each of the insulators 52, and a loosened section of the jumper wire 55U is pushed inward of the wall portions 59 in the radial direction from the gap S1 between these two wall portions 59 to form the pushed portion 60. The loosened section of the jumper wire 55U is pushed into the gap S1 to form the pushed portion 60, and therefore, looseness of the jumper wire 55U is suppressed. Thus, expansion of the jumper wire 55U to the outer peripheral side can be suppressed. In the present embodiment, two gaps S1 are present between one U-phase coil 53U and the other U-phase coil 53U, and therefore, the pushed portions 60 are formed at two locations.

The jumper wires 55V, 55W are drawn in the same shape as that of the jumper wire 55U. That is, each of the jumper wires 55V, 55W is drawn from the gap S1 to the outer peripheral side, is hooked on the wall portion 59, is drawn to the outside of the wall portion 59 in the radial direction, is guided by the wall portion 59, and is drawn in the circumferential direction on the outside of the wall portion 59 in the radial direction. Moreover, when each of the jumper wires 55V, 55W passes through two insulators 52, the pushed portions 60 are formed at two locations. Then, each of the jumper wires 55V, 55W is hooked on the wall portion 59 formed at the insulator 52 provided with the other coil 53 of the same phase, and is drawn from the gap S1 to the side of the coil 53.

### (Common Wire Guide Portion and Conductive Wire Guide Portion)

As shown in FIG. 6 and FIG. 8, in the present embodiment, an end portion of the conductive wire 55 forming the U-phase coil 53U, an end portion of the conductive wire 55 forming the V-phase coil 53V, and an end portion of the conductive wire 55 forming the W-phase coil 53W are connected to each other on the opposite-output side L2 of the stator 11 to form the common wire 55A. For example, three conductive wires 55 are soldered to form the common wire 55A. Further, on the opposite-output side L2 of the stator 11, the conductive wires 55 respectively connected to the U-phase coil 53U, the V-phase coil 53V, and the W-phase coil 53W are drawn to the connector 54.

The shape of each of the wall portions 58 varies depending on the angular position of the insulator 52. That is, the wall portion 58 includes three types of: first wall portions 58A formed at two insulators 52A located on the opposite side to the connector 54 in the radial direction; second wall portions 58B formed at two insulators 52B adjacent, in the circumferential direction, to the insulator 52 at the same angular position as that of the connector 54; and third wall portions 58C formed at other four insulators 52C. The third wall portion 58C is in the same shape as that of the above-described wall portion 59 standing toward the output side L1. That is, each of four insulators 52 includes two third wall portions 58C spaced apart in the circumferential direction, and also includes a gap S2 formed between these two wall portions 58C.

As shown in FIG. 6 and FIG. 8, each of the first wall portions 58A includes first common wire support portions 62 provided at both ends in the circumferential direction, and a second common wire support portion 63 provided at the center in the circumferential direction. The second common wire support portion 63 extends in a direction orthogonal to the center line Q of the insulator 52A in the circumferential direction, and the first common wire support portions 62 are respectively connected to both ends the second common wire support portion 63 at an obtuse angle. That is, the first wall portion 58A entirely has such a shape that a width in the circumferential direction increases toward the outside in the radial direction. Each of the two first common wire support portions 62 extends inclined inward in the radial direction toward the center (the center line Q) side of the insulator 52A in the circumferential direction. A groove portion 61A extending in the direction of the axis L is formed at an outer surface of the second common wire support portion 63 in the radial direction. The groove portion 61A is located at the center of the insulator 52A in the circumferential direction. Further, the groove portion 61A extends across an entire area of the second common wire support portion 63 in the direction of the axis L.

The second wall portions 58B are provided at the insulators 52B adjacent to the connector 54 in the circumferential direction. Each of the second wall portions 58B is a conductive wire guide portion configured to guide the conductive wire 55 drawn from the coil 53 to the connector 54. The second wall portion 58B is in the form of a flat plate orthogonal to the center line Q of the insulator 52B in the circumferential direction, and an edge thereof on a first side (i.e., the side of the connector 54) in the circumferential direction is closer to the center line Q than an edge thereof on a second side. That is, the second wall portion 58B is not in a symmetrical shape in the circumferential direction with respect to the center line Q, but is in such a shape that the edge on the side of the connector 54 is cut off. As shown in FIG. 6 and FIG. 8, the conductive wire 55 drawn from the coil 53 to the connector 54 is arranged on the inner side of the second wall portion 58B in the radial direction, and is drawn in the circumferential direction along the second wall portion 58B. A groove portion 61B extending in the direction of the axis L is formed at an outer surface of the second wall portion 58B in the radial direction. The groove portion 61B is located at the center of the insulator 52B in the circumferential direction. Further, the groove portion 61B extends across an entire area of the second wall portion 58B in the direction of the axis L.

In the present embodiment, when the stator 11 is arranged in a mold and the resin sealing member 13 is formed, pressing pins 18 (see FIG. 8), which are pressing members configured to press the stator 11 in the direction of the axis L against an end surface of the mold, are used. The groove portion 61A is in a recessed shape for avoiding contact between the pressing pin 18 arranged at an angular position at which the first wall portion 58A is arranged and the first wall portion 58A. Similarly, the groove portion 61B is in a recessed shape for avoiding contact between the pressing pin 18 arranged at an angular position at which the second wall portion 58B is arranged and the second wall portion 58B.

As described later, in the present embodiment, six pressing pins 18 are used. The resin sealing member 13 is provided with six holes 17 (see FIG. 4) as arrangement marks of the pressing pins 18. Two of six pressing pins 18 press the centers, in the circumferential direction, of the insulators 52A provided with the first wall portions 58A, two of the remaining four pressing pins 18 press the centers, in the circumferential direction, of the insulators 52B provided with the second wall portions 58B, and the remaining two pressing pins 18 press the centers, in the circumferential direction, of the insulators 52C provided with the third wall portions 58C. The third wall portion 58C is arranged to avoid the center of the insulator 52C in the circumferential direction, and therefore, does not contact the pressing pin 18.

The holes 17 as the arrangement marks of six pressing pins 18 are provided at angular positions coincident with the centers of the insulators 52 in the circumferential direction. At the insulator 52A provided with the first common wire support portions 62, the second common wire support portion 63 connected to the first common wire support portions 62 is arranged at an angular position (the center in the circumferential direction) at which the hole 17 is formed. By providing the second common wire support portion 63 at the angular position at which the pressing pin 18 is provided as described above, the common wire 55A can be supported so as not to protrude to the side of the pressing pin 18. Thus, contact between the pressing pin 18 and the common wire 55A can be prevented. Further, for example, a situation where disconnection of the common wire 55A occurs due to the common wire 55A being caught between the pressing pin 18 and the insulator 52A can be prevented.

Similarly, at the insulator 52B provided with the second wall portion 58B, the second wall portion 58B is arranged at an angular position (the center in the circumferential direction) at which the hole 17 is formed. By providing the second wall portion 58B at the angular position at which the pressing pin 18 is provided as described above, the conductive wire 55 drawn to the connector 54 can be supported so as not to protrude to the side of the pressing pin 18. Thus, contact between the pressing pin 18 and the conductive wire 55 can be prevented. Further, for example, a situation where disconnection of the conductive wire 55 occurs due to the conductive wire 55 being caught between the pressing pin 18 and the insulator 52B can be prevented.

As shown in FIG. 8, the common wire 55A is drawn to the outer peripheral side from the gap S2 between the third wall portions 58C provided at the insulator 52C adjacent, in the circumferential direction, to the insulator 52A provided with the first common wire support portions 62. Then, after having been hooked on the third wall portion 58C located adjacent to the first common wire support portion 62 and having been drawn to the side of the first common wire support portion 62 through the outside of the third wall portion 58C in the radial direction, the common wire 55A is pushed to the inner peripheral side through a gap S3 between the third wall portion 58C and the first common wire support portion 62. That is, the third wall portion 58C adjacent to the first common wire support portion 62 in the circumferential direction functions as a common wire guide portion configured to guide the common wire 55A.

The first common wire support portion 62 is in a shape extending inward in the radial direction as a distance from the third wall portion 58C increases. In other words, the first common wire support portion 62 is in a shape extending inward in the radial direction toward a tip end side of the common wire 55A. In such a shape, the first common wire support portion 62 supports the common wire 55A from the outside in the radial direction. Thus, the common wire 55A is supported in a state in which a tip end thereof faces the inner peripheral side, and a state in which the common wire 55A is less detached from the first common wire support portion 62 is brought. Further, the second common wire support portion 63 connected to the first common wire support portions 62 is arranged on the tip end side of the common wire 55A, and therefore, a tip end portion of the common wire 55A is supported so as not to protrude to the outside of the stator 11 in the radial direction. That is, the common wire 55A is temporarily fixed to the insulator 52. By forming the resin sealing member 13 in this state, protrusion of the common wire 55A outward in the radial direction from the stator 11 is prevented.

### (Connector)

The connector 54 is in such a shape that a male external connector is attachable thereto and detachable therefrom. The connector 54 is connected to one of the plurality of insulators 52. The connector 54 includes a substantially rectangular parallelepiped connector housing 30, a connection portion 31 connecting the connector housing 30 and the insulator 52, and terminal pins 40 held by the connector housing 30. The connector housing 30 is arranged on the outer peripheral side of the insulator 52 and on the opposite-output side L2 of the stator core 51, and is connected to a section (the core outer side surface covering portion 52a) of the insulator 52 located on the outer peripheral side of the coil 53 through the connection portion 31. The connector housing 30 and the connection portion 31 are integrally formed with the insulator 52.

The connector 54 is a female connector 54 including three terminal pins 40 of: the terminal pin 40 to which one end portion of the conductive wire 55 forming the U-phase coil 53U is connected, the terminal pin 40 to which one end portion of the conductive wire 55 forming the V-phase coil 53V is connected, and the terminal pin 40 to which one end portion of the conductive wire 55 forming the W-phase coil 53W is connected.

The connector housing 30 is in a substantially rectangular parallelepiped shape opening to the opposite-output side L2. That is, the connector housing 30 is provided with a connection opening 30a opening to the opposite-output side L2. The connector housing 30 includes a rectangular tubular cylinder portion 33 extending in the direction of the axis L, and a bottom portion 32 closing an end portion of the cylinder portion 33 on the output side L1. The connection opening 30a is provided at an end portion of the cylinder portion 33 on the opposite-output side L2. As shown in FIG. 6, the cylinder portion 33 includes an inner wall 33a located on the center side (i.e., the side of the insulator 52) of the stator 11, an outer wall 33b parallel to the inner wall 33a, and side walls 33c, 33d connecting the inner wall 33a and the outer wall 33b. An internal space of the connector housing 30 is divided into three by partition walls 33e, 33f parallel to the side walls 33c, 33d. A terminal connection portion 41 (see FIG. 2A) as an end portion of the terminal pin 40 is arranged in each of spaces partitioned by the partition walls 33e and 33f When the male external connector is attached to the connection opening 30a, terminals provided at the external connector and the terminal pins 40 contact each other.

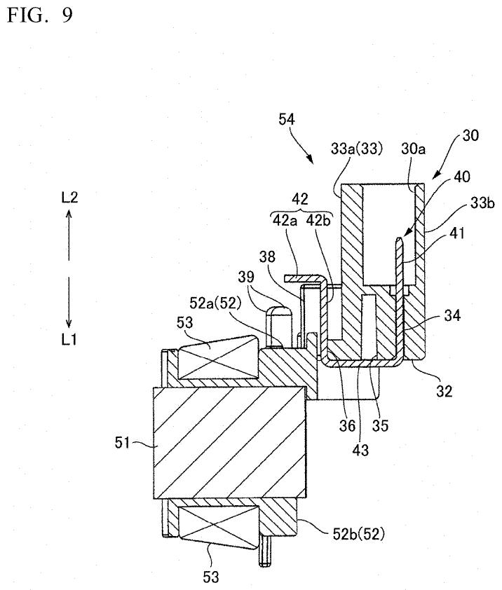

FIG. 9 is a cross-sectional view of the connector 54 and the insulator 52. As shown in FIG. 5 and FIG. 7, the bottom portion 32 is provided with the same number of through-holes 34 as that of the terminal pins 40. The connector housing 30 of the present embodiment is attached with three terminal pins 40, and therefore, the through-holes 34 are formed at three locations. Three through-holes 34 are arranged in line in the direction orthogonal to the center line Q, in the circumferential direction, of the insulator 52 connected to the connector 54. As shown in FIGS. 5, 7, and 9, a surface of the bottom portion 32 on the output side L1 is provided with a recessed portion 35 located on the inner side (i.e., the side of the insulator 52) of the through-holes 34 in the radial direction. The recessed portion 35 is in a thin-walled shape recessed toward the opposite-output side L2, and extends in a groove shape along a direction in which three through-holes 34 are arranged. Further, a surface of the connection portion 31 on the output side L1 is provided with the same number of through-holes 36 (see FIG. 9) as that of the through-holes 34. That is, a surface of the connector 54 on the output side L1 is provided with three pairs of through-holes 34, 36. A holding groove 37 (see FIG. 5 and FIG. 7) crossing the recessed portion 35 is provided between the through-holes 34, 36 in each of three pairs. A section (a coupling portion 43 described later) of the terminal pin 40 extending from the through-hole 34 to the through-hole 36 is held by the holding groove 37.

The terminal pin 40 is formed by bending a metal wire having a rectangular cross-sectional shape. Note that, the terminal pin 40 may be formed also by bending a metal wire having a circular cross-sectional shape. As shown in FIG. 9, the terminal pin 40 includes the terminal connection portion 41 press-fitted in the connector housing 30 and protruding toward the connection opening 30a, a conductive wire connection portion 42 arranged between the connector housing 30 and the insulator 52, and the coupling portion 43 connecting the terminal connection portion 41 and the conductive wire connection portion 42. The terminal connection portion 41 and the conductive wire connection portion 42 extend in parallel with the direction of the axis L. Further, the coupling portion 43 extends in the direction orthogonal to the direction of the axis L, and is substantially perpendicularly connected to the terminal connection portion 41 and the conductive wire connection portion 42.

As shown in FIG. 9, the terminal pin 40 is attached to the connector housing 30 by press-fitting the terminal connection portion 41 in the through-hole 34 in the direction of the axis L and inserting the conductive wire connection portion 42 into the through-hole 36. As described above, by holding the coupling portion 43 by the holding groove 37 formed on the outer side surface of the connector housing 30, rotation of the terminal pin 40 is prevented. At the time of assembly of the terminal pins 40 to the connector housing 30, the conductive wire connection portion 42 is entirely in a linear shape. A tip end of the conductive wire connection portion 42 is provided with a retaining portion 42a formed by substantially perpendicularly bending a tip end portion of the conductive wire connection portion 42 inward in the radial direction after assembly to the connector housing 30. That is, the conductive wire connection portion 42 is formed of a linear portion 42b linearly extending along the inner wall 33a, and the retaining portion 42a.

The conductive wire connection portion 42 is a section around which the conductive wire 55 connecting the coil 53 and the terminal pin 40 is wound. The conductive wire connection portion 42 is in a retaining shape allowing detachment of the conductive wire 55 wound around the conductive wire connection portion 42 to be suppressed. The retaining shape of the present embodiment is such a bent shape that the tip end portion (the retaining portion 42a) of the conductive wire connection portion 42 is bent from the section (the linear portion 42b) connected to the tip end portion. The retaining portion 42a is bent such that a tip end thereof faces inward in the radial direction. Note that a bending angle of the retaining portion 42a is not necessarily a substantially right angle. For example, the bending angle may be an obtuse angle.

As shown in FIG. 6, three conductive wire connection portions 42 are arranged at regular intervals in a direction orthogonal to the radial direction along the inner wall 33a of the connector housing 30. The connector housing 30 includes wall portions 38 perpendicularly protruding inward in the radial direction from the inner wall 33a. The wall portions 38 are provided at two locations as intermediate positions between adjacent conductive wire connection portions 42. As shown in FIG. 8 and FIG. 9, the wall portion 38 is configured such that an inner edge thereof in the radial direction is located on the inner side of the linear portion 42b in the radial direction. On the other hand, the wall portion 38 is configured such that an edge thereof in the direction of the axis L is located on the output side L1 with respect to the retaining portion 42a. In other words, the height of the wall portion 38 in a direction along the linear portion 42b is lower than a height to the bending position at which the retaining portion 42a as the tip end portion and the linear portion 42b are connected to each other. That is, the wall portion 38 is in a shape with the width reaching between adjacent linear portions 42b and with the height not reaching between adjacent retaining portions 42a.

As shown in FIG. 6, the insulator 52 integrally formed with the connector 54 includes four columnar guide protruding portions 39 protruding from an opposite-output-side-L2 surface of the core outer side surface covering portion 52a covering an outer peripheral surface of the stator core 51. The four guide protruding portions 39 are arranged at constant pitches in the circumferential direction. Note that the position, the interval and the number of the guide protruding portions 39 can be changed as necessary. The single conductive wire 55 is connected to each of three conductive wire connection portions 42. Three conductive wires 55 forming the U-phase coil 53U, the V-phase coil 53V, and the W-phase coil 53W are guided by four guide protruding portions 39, and are drawn to the conductive wire connection portions 42. That is, four guide protruding portions 39 guide one of three conductive wires 55 from the coil 53 located on the inner peripheral side of the connector housing 30 to a middle one of three conductive wire connection portions 42, guide one of the remaining two conductive wires 55 from the coil 53 located on the first side in the circumferential direction with respect to the coil 53 located on the inner peripheral side of the connector housing 30 to the conductive wire connection portion 42 located at an end on the first side in the circumferential direction, and guide the last conductive wire 55 from the coil 53 located on the second side in the circumferential direction with respect to the coil 53 located on the inner peripheral side of the connector housing 30 to the conductive wire connection portion 42 located at an end on the second side in the circumferential direction. Note that in an example of FIGS. 6 and 8, the U-phase coil 53U is provided at the insulator 52 provided on the inner peripheral side of the connector housing 30, but arrangement of the coils 53 of three phases may be different from those of the examples of FIG. 6 and FIG. 8.

The conductive wire 55 is guided by the guide protruding portion 39, is drawn toward the conductive wire connection portion 42, and is drawn to the retaining portion 42a along the linear portion 42b. For the conductive wire 55 drawn along the linear portion 42b, short circuit is prevented by the wall portion 38 arranged between adjacent linear portions 42b. The conductive wire 55 is wound around the linear portion 42b or the retaining portion 42a and soldered to the linear portion 42b or the retaining portion 42a. As described above, the wall portion 38 has the height not reaching the retaining portion 42a, and therefore, soldering can be performed in a state in which a soldering iron is brought close to upper ends of the retaining portion 42a and the linear portion 42b without being interfered by the wall portion 38.

### (Resin Sealing Member)

As shown in FIG. 2A to FIG. 4, the resin sealing member 13 includes a substantially-discoid sealing member bottom portion 65 covering the coils 53, the insulators 52, and the stator core 51 from the opposite-output side L2. Further, the resin sealing member 13 includes a connector sealing portion 66 extending from the sealing member bottom portion 65 to the outer peripheral side and covering the connector 54, and a sealing member cylinder portion 67 extending from the sealing member bottom portion 65 to the output side L1 and covering the coils 53, the insulators 52, and the stator core 51. The sealing member cylinder portion 67 is in a thick cylindrical shape. The center axis of the sealing member cylinder portion 67 is coincident with the axis L of the motor 2.

A bearing member holding recessed portion 68 is provided at a center section of the sealing member bottom portion 65. The bearing member holding recessed portion 68 holds the first bearing member 15 configured to rotatably support the end portion of the rotating shaft 5 of the rotor 10 on the opposite-output side L2. The first bearing member 15 is made of resin, and is in a shape including a tubular support portion provided with a through-hole in which the rotating shaft 5 is arranged and a flange portion expanding to the outer peripheral side from the end portion of the cylinder portion on the output side L1. The contour of the first bearing member 15 as viewed in the direction of the axis L is a D-shape. The first bearing member 15 is fixed to the bearing member holding recessed portion 68 in a state in which the flange portion contacts the sealing member bottom portion 65 from the output side L1. The first bearing member 15 is configured such that the support portion into which the rotating shaft 5 is inserted functions as a radial bearing of the rotating shaft 5 and the flange portion functions as a thrust bearing of the rotor 10. That is, the first bearing plate 45 fixed to the holding member 21 of the rotor 10 slides on the flange portion of the first bearing member 15.

As shown in FIG. 2A and FIG. 2B, the sealing member bottom portion 65 includes a tubular bearing support section 65a surrounding the first bearing member 15 from the outer peripheral side in the radial direction, a circular closing section 65b closing a lower end opening of the bearing support section 65a, a coil sealing section 65c located below the coil 53, and a connection section 65d connecting between the bearing support section 65a and the coil sealing section 65c. The bearing support section 65a and the closing section 65b form the bearing member holding recessed portion 68. A surface of the coil sealing section 65c on the opposite-output side L2 includes a tapered surface 65e inclined to the opposite-output side L2 toward the outer peripheral side along the shape of each coil 53 wound around the insulator 52, and an annular surface 65f provided on the outer peripheral side of the tapered surface 65e perpendicularly to the direction of the axis L.

As shown in FIG. 2a, FIG. 4, and FIG. 5, the connector sealing portion 66 is entirely in a substantially rectangular parallelepiped shape. The connector sealing portion 66 includes a connector-sealing-portion bottom portion 66a covering the output side L1 of the connector 54, a connector-sealing-portion outer peripheral portion 66b covering the outside of the connector 54 in the radial direction and both sides of the connector 54 in the circumferential direction, and a connector-sealing-portion inner peripheral portion 66c located on the inner peripheral side of the connector housing 30, covering the opposite-output side L2 of the connection portion 31, and protruding from the sealing member bottom portion 65 to the opposite-output side L2. The connector-sealing-portion bottom portion 66a and the connector-sealing-portion outer peripheral portion 66b protrude to the outer peripheral side from the sealing member cylinder portion 67. Further, the connector-sealing-portion inner peripheral portion 66c is in a shape raised by a single step from the annular surface 65f of the sealing member bottom portion 65. That is, an end surface 66d of the connector-sealing-portion inner peripheral portion 66c on the opposite-output side L2 is at a position protruding to the opposite-output side L2 by a single step with respect to the annular surface 65f of the sealing member bottom portion 65.

The connector 54 is configured such that the end portion of the connector housing 30 having the connection opening 30a to and from which the male connector is attached and detached protrudes from the connector sealing portion 66 to the opposite-output side L2, and is exposed to the outside. The connection opening 30a is provided at a position protruding from the end surface 66d of the connector sealing portion 66 on the opposite-output side L2 by a dimension H (see FIG. 4). The connector 54 is configured such that only the end portion of the connector housing 30 having the connection opening 30a is exposed to the outside and the coupling portions 43 and the conductive wire connection portions 42 of the terminal pins 40 are completely covered with the connector sealing portion 66. Thus, the connector sealing portion 66 prevents detachment of the terminal pins 40, and protects the terminal pins 40 from fluid. Further, the conductive wire 55 drawn from the coil 53 to the connector 54 is also covered with the connector sealing portion 66, and is protected from fluid.

As shown in FIGS. 2A, FIG. 2B, and FIG. 3, the sealing member cylinder portion 67 includes a large-diameter cylinder section 81 connected to the sealing member bottom portion 65 and a small-diameter cylinder section 82 having a smaller outside diameter dimension than that of the large-diameter cylinder section 81. The small-diameter cylinder section 82 includes a first small-diameter cylinder section 82a forming an end portion of the sealing member cylinder portion 67 on the output side L1, and a second small-diameter cylinder section 82b provided between the first small-diameter cylinder section 82a and the large-diameter cylinder section 81. The first small-diameter cylinder section 82a has a slightly smaller outside diameter than that of the second small-diameter cylinder section 82b.

At an outer peripheral surface of the sealing member cylinder portion 67, a resin-sealing-member-side position control surface 70 as a step surface facing the output side L1 is formed at a boundary between the second small-diameter cylinder section 82b and the large-diameter cylinder section 81. The resin-sealing-member-side position control surface 70 is orthogonal to the direction of the axis L. As described later, the resin-sealing-member-side position control surface 70 is a surface contacting the cover member 14 in the direction of the axis L. Further, the sealing member cylinder portion 67 includes, at the end portion on the output side L1, a resin-sealing-member-side fixing surface 71 as an annular end surface orthogonal to the direction of the axis L. As described later, the resin-sealing-member-side fixing surface 71 faces the cover member 14 with a predetermined gap interposed therebetween. The cover member 14 is fixed to the resin sealing member 13 with an adhesive arranged in the gap between the resin-sealing-member-side fixing surface 71 and the cover member 14.

The outside diameter of the large-diameter cylinder section 81 is larger than the outside diameter of the annular portion 56 of the stator core 51, and the outside diameter of the second small-diameter cylinder section 82b is smaller than the outside diameter of the annular portion 56 of the stator core 51. Further, the resin-sealing-member-side position control surface 70 is located on the same plane as the opposite-output side end surface 56a of the annular portion 56 of the stator core 51. Thus, at an inner peripheral section of the resin-sealing-member-side position control surface 70, a plurality of arc-shaped openings 83 (see FIG. 3) is formed such that an outer peripheral edge section of the opposite-output side end surface 56a of the annular portion 56 of the stator core 51 is exposed to the output side L1.

As shown in FIGS. 2A, FIG. 2B and FIG. 3, an inner peripheral surface of the sealing member cylinder portion 67 is, from the opposite-output side L2 to the output side L1, provided with a small-diameter inner peripheral surface section 67a and a large-diameter inner peripheral surface section 67b having a larger inside diameter than that of the small-diameter inner peripheral surface section 67a. As shown in FIG. 2A and FIG. 2B, the small-diameter inner peripheral surface section 67a is provided with a plurality of openings through which the inner peripheral end surface 57a of each salient pole portion 57 of the stator core 51 is exposed to the inner peripheral side. Further, as shown in FIG. 3, the small-diameter inner peripheral surface section 67a is provided with a plurality of groove-shaped cutout portions 69 extending in the direction of the axis L. Each of the plurality of cutout portions 69 is located at the center of each salient pole portion 57 of the stator core 51 in the circumferential direction, and extends from an output-side end surface 57b (see FIG. 5) of the salient pole portion 57 to an end surface of the small-diameter inner peripheral surface section 67a on the output side L1. Thus, at an angular position at which the cutout portion 69 is provided, the output-side end surface 57b of the salient pole portion 57 of the stator core 51 is exposed to the output side L1.

Four engagement protruding portions 85 protruding to the outer peripheral side are provided at regular angular intervals at an outer peripheral surface of the large-diameter cylinder section 81. The engagement protruding portions 85 each engage with a rotation engagement portion 86 provided at the cover member 14 as described later. The engagement protruding portion 85 engages with the rotation engagement portion 86 to restrict detachment of the cover member 14 from the resin sealing member 13.

The resin sealing member 13 completely covers the coils 53, and protects the coils 53 from fluid. Further, the resin sealing member 13 is, except for the opening (the connection opening 30a) to and from which the male connector is attached and detached, integrally formed, including the connector sealing portion 66 covering the connector 54, and therefore, the resin sealing member 13 prevents detachment of the terminal pins 40 assembled to the connector 54, and protects each connection portion between the terminal pin 40 and the conductive wire 55 from fluid. The resin sealing member 13 is made of a bulk molding compound (BMC). In the present embodiment, the stator 11 is arranged in the mold, and a resin material is injected into the mold and is cured. In this manner, the resin sealing member 13 is formed. That is, the resin sealing member 13 is integrally formed with the stator 11 by insert molding.

When insert molding is performed, resin is injected into the mold to form the resin sealing member 13 in a state in which the stator core 51 arranged in the mold is brought into contact with the mold in the radial direction and the direction of the axis L and is positioned. Accordingly, the accuracy of relative positions of the stator core 51 and the resin sealing member 13 is improved. For example, a columnar mold section is provided in the mold, and an outer peripheral surface of the mold section is brought into contact with the inner peripheral end surface 57a of each salient pole portion 57 to position the stator core 51 in the radial direction. As a result, the inner peripheral end surface 57a of each salient pole portion 57 of the stator core 51 is exposed through the resin sealing member 13 as described above. Alternatively, when insert molding is performed, a first contact section contactable with the output-side end surface 57b of each salient pole portion 57 and a second contact section contactable with the output-side end surface 56b of the annular portion 56 are provided in the mold, and these first and second contact sections are brought into contact with the stator core 51 to position the stator core 51 in the direction of the axis L. As a result, part of the output-side end surface 57b of each salient pole portion 57 of the stator core 51 is exposed to the output side L1 as described above. Further, an outer peripheral section of the output-side end surface 56b of the annular portion 56 is exposed to the output side L1.

As shown in FIG. 4, the sealing member bottom portion 65 is provided with the plurality of holes 17 communicating from a surface of the sealing member bottom portion 65 on the opposite-output side L2 to an end surface of the insulator 52 on the opposite-output side L2. In the present embodiment, six holes 17 are formed at the sealing member bottom portion 65. Specifically, pairs of holes 17 arranged at 40° pitches about the axis L are formed at three locations at 120° pitches. As in the description of the structure of the wall portion 58 provided at the insulator 52, the holes 17 are each in the shape corresponding to the pressing pin 18 for pushing, in the direction of the axis L, the stator 11 set in the mold and pressing the stator 11 against a support surface (the first contact section and the second contact section described above) in the mold upon molding.

### (Cover Member)

The cover member 14 is made of resin, and is fixed to the output side L1 of the resin sealing member 13. The cover member 14 includes a discoid cover-member ceiling portion 91 and a cover-member cylinder portion 92 protruding from the cover-member ceiling portion 91 to the opposite-output side L2. At the center of the cover-member ceiling portion 91, a through-hole 93 penetrating in the direction of the axis L is provided. A circular recessed portion 94 surrounding the through-hole 93 is provided at the center of a surface of the cover-member ceiling portion 91 on the output side L1, and a circular ring-shaped seal member 95 is arranged at the circular recessed portion 94. The seal member 95 is arranged in a gap between the rotating shaft 5 and the cover member 14.

As shown in FIG. 4, a bearing member holding cylinder portion 97 provided coaxially with the through-hole 93 is provided at a center section of a surface of the cover-member ceiling portion 91 on the opposite-output side L2. As shown in FIG. 2A, the second bearing member 16 is held in a center hole of the bearing member holding cylinder portion 97. The second bearing member 16 is configured such that the same member as the above-described first bearing member 15 is arranged in a direction opposite to the direction of the axis L. That is, the second bearing member 16 is made of resin, and is in a shape including a tubular support portion provided with a through-hole in which the rotating shaft 5 is arranged and a flange portion expanding to the outer peripheral side from the end portion of the cylinder portion on the opposite-output side L2. The second bearing member 16 is fixed to the bearing member holding cylinder portion 97 in a state in which the flange portion contacts the bearing member holding cylinder portion 97 from the opposite-output side L2. The second bearing member 16 is configured such that the support portion into which the rotating shaft 5 is inserted functions as a radial bearing of the rotating shaft 5 and the flange portion functions as a thrust bearing of the rotor 10. That is, the second bearing plate 46 fixed to the holding member 21 of the rotor 10 slides on the flange portion of the second bearing member 16.

As shown in FIG. 4, a surface of the cover-member ceiling portion 91 on the opposite-output side L2 is provided with a circular ring-shaped cover-member-side fixing surface 72 connected to an inner peripheral surface of the cover-member cylinder portion 92 along an outer peripheral edge of the cover-member ceiling portion 91. Further, the surface of the cover-member ceiling portion 91 on the opposite-output side L2 is provided with a circular inner annular rib 99 between the bearing member holding cylinder portion 97 and the cover-member-side fixing surface 72. The bearing member holding cylinder portion 97, the cover-member-side fixing surface 72, and the inner annular rib 99 are provided coaxially. Further, a plurality of radial ribs 98 and a plurality of first adhesive reservoir portions 100 are provided between the inner annular rib 99 and the cover-member-side fixing surface 72. In addition, a plurality of radial ribs 96 is provided between the inner annular rib 99 and the bearing member holding cylinder portion 97.

The inner annular rib 99 and the radial ribs 98, 96 are protruding portions protruding to the opposite-output side L2. Further, the first adhesive reservoir portions 100 are each a recessed portion more recessed toward the output side L1 than the cover-member-side fixing surface 72 and the radial rib 98. The first adhesive reservoir portion 100 is a recessed portion utilizing the thin-walled shape of the cover member 14. That is, the first adhesive reservoir portion 100 also forms the thin-walled shape of the cover member 14. Further, on the inner peripheral side of the inner annular rib 99, a recessed portion in a thin-walled shape is also formed between the radial ribs 96.

As shown in FIG. 2A and FIG. 4, the inside diameter of the cover member cylinder portion 92 gradually increases from the output side L1 to the opposite-output side L2. That is, the inner peripheral surface of the cover member cylinder portion 92 includes, in order from the output side L1, a first small-diameter inner peripheral surface 92a, a second small-diameter inner peripheral surface 92b, and a large-diameter inner peripheral surface 92c. A cover-member-side position control surface 73 as an annular step surface facing the opposite-output side L2 is formed at a boundary between the second small-diameter inner peripheral surface 92b and the large-diameter inner peripheral surface 92c. The cover-member-side position control surface 73 is a plane orthogonal to the axis L.

The cover member cylinder portion 92 includes an upper annular cylinder section 92d overlapping with the small-diameter cylinder section 82 of the resin sealing member 13 in the direction of the axis L and covering the small-diameter cylinder section 82 of the resin sealing member 13 from the outer peripheral side, and a lower annular cylinder section 92e located on the outer peripheral side of the large-diameter cylinder section 81 of the resin sealing member 13. The upper annular cylinder section 92d is a section on the output side L1 with respect to the cover-member-side position control surface 73. Further, the lower annular cylinder section 92e is a protruding portion protruding to the opposite-output side L2 with respect to the cover-member-side position control surface 73 and covering the outer peripheral side of the resin sealing member 13. As shown in FIG. 4, at the lower annular cylinder section 92e of the cover member cylinder portion 92, the rotation engagement portions 86 engaging with the engagement protruding portions 85 of the resin sealing member 13 are provided at four locations in the circumferential direction.

### (Positioning Structure and Fixing Structure for Cover Member)

The cover member 14 covers the resin sealing member 13 from the output side L1 in a state in which the rotor 10 is arranged on the inside of the resin sealing member 13 and the rotor 10 is supported by the first bearing member 15. When the cover member 14 covers the resin sealing member 13, a lower end portion of the inner annular rib 99 is, as shown in FIG. 2A and FIG. 2B, fitted on the inner peripheral side of the sealing member cylinder portion 67 of the resin sealing member 13. Accordingly, the cover member 14 and the resin sealing member 13 are positioned in the radial direction, and the axis L of the rotating shaft 5 and the center axis of the stator 11 are coincident with each other.

The cover member 14 is positioned in the direction of the axis L by contact, in the direction of the axis L, between the cover-member-side position control surface 73 provided at the cover member cylinder portion 92 and the resin-sealing-member-side position control surface 70 as the step surface provided at an outer peripheral surface of the resin sealing member 13. Accordingly, the cover-member ceiling portion 91 covers the rotor 10 and the resin sealing member 13 from above with the rotating shaft 5 penetrating in an up-down direction. Further, the seal member 95 arranged in the circular recessed portion 94 of the cover-member ceiling portion 91 seals between the rotating shaft 5 and each of the cover member 14 and the second bearing member 16. In addition, the cover member cylinder portion 92 surrounds a section of the resin sealing member 13 on the output side L1 from the outer peripheral side. Thereafter, the cover member 14 and the resin sealing member 13 are rotated relative to each other in the circumferential direction, and as shown in FIG. 1, the engagement protruding portions 85 of the resin sealing member 13 and the rotation engagement portions 86 of the cover member 14 engage with each other.

When the cover member 14 covers the resin sealing member 13, an adhesive is applied to the resin-sealing-member-side fixing surface 71 (see FIG. 3), which is an end surface of the sealing member cylinder portion 67 on the output side L1. As shown in FIG. 2B, when the cover-member-side position control surface 73 and the resin-sealing-member-side position control surface 70 contact each other in the direction of the axis L, the resin-sealing-member-side fixing surface 71 faces the cover-member-side fixing surface 72 and tip end surfaces of the radial ribs 98 with a predetermined gap interposed therebetween. The adhesive is cured while filling the gap. Thus, the cover-member-side fixing surface 72 and the tip end surfaces of the radial ribs 98 are fixed to the resin-sealing-member-side fixing surface 71 through an adhesive layer 110.

The first adhesive reservoir portion 100 is provided at a position adjacent to the cover-member-side fixing surface 72 on the inner peripheral side. Thus, an excessive adhesive overflowing to the inner peripheral side of the cover-member-side fixing surface 72 is held by the first adhesive reservoir portion 100. Further, the cover member 14 includes a second adhesive reservoir portion 101 provided between the cover-member-side fixing surface 72 and the cover-member-side position control surface 73. Thus, an excessive adhesive overflowing to the outer peripheral side from the cover-member-side fixing surface 72 is held by the second adhesive reservoir portion 101.

### (Main Features and Advantageous Effects of the Present Embodiment)

As described above, the motor 2 and the pump device 1 of the present embodiment include the common wire 55A connecting the conductive wires 55 drawn from the coils 53 of each phase, and the first common wire support portions 62 supporting the common wire 55A from the outside in the radial direction are formed at the insulator 52. The first common wire support portions 62 are each in the shape extending inward in the radial direction toward the tip end side of the common wire 55A, and therefore, protrusion of the common wire 55A to the outer peripheral side of the first common wire support portions 62 can be suppressed. Thus, exposure of the common wire 55A to the outer peripheral side of the stator 11 can be suppressed.

In the present embodiment, the stator 11 is configured so that the common wire 55A can be temporarily fixed to the insulator 52 with the common wire 55A being held by the first common wire support portions 62. Thus, in a case where the stator 11 is sealed with the resin sealing member 13, the common wire 55A can be held so as not to protrude to the outside of the resin sealing member. Thus, the common wire 55A can be insulated. Further, the first common wire support portions 62 are integrally formed with the insulator 52, and therefore, another component for suppressing protrusion of the common wire 55A is not necessarily used. Thus, an increase in the number of components can be suppressed.

In the present embodiment, the insulator 52 provided with the first common wire support portions 62 includes the second common wire support portion 63 connected to the end portions of the first common wire support portions 62, the end portions being on the inner side in the radial direction, and can support the tip end portion of the common wire 55A by the second common wire support portion 63. Thus, exposure of the common wire 55A to the outer peripheral side of the stator 11 can be suppressed. Further, the third wall portion 58C configured to guide the common wire 55A to the insulator 52 adjacent, in the circumferential direction, to the insulator 52 provided with the first common wire support portions 62 is provided, and therefore, the common wire 55A can be drawn to the first common wire support portions 62. In addition, the first common wire support portion is provided at a single location on each end side of the insulator in the circumferential direction, and therefore, the common wire 55a can be supported regardless of whether the direction of drawing the common wire is a first side or a second side in the circumferential direction.

In the present embodiment, when the resin sealing member 13 covering the stator 11 is formed, the pressing pins 18 configured to press the stator 11 in the direction of the axis L against the mold are used. Thus, the resin sealing member 13 is provided with the holes 17 as the arrangement marks of the pressing pins 18. The second common wire support portion 63 is arranged in an angular range including the angular position of the hole 17. Accordingly, the common wire 55A can be supported so as not to protrude to the pressing pin side, contact between the pressing pin 18 and the common wire 55A can be prevented by the second common wire support portion 63. Thus, disconnection of the common wire 55A due to the common wire 55A being caught between the pressing pin 18 and the insulator 52 can be prevented.

In the present embodiment, the insulator 52 adjacent, in the circumferential direction, to the insulator 52 connected to the connector 54 includes the conductive wire guide portion (the second wall portion 58B) configured to guide the conductive wire 55 drawn from the coil 53 to the connector 54. The second wall portion 58B is a single continuous wall portion, and is arranged in an angular range including the angular position of the hole 17. Thus, contact between the pressing pin 18 and the common wire 55A can be prevented by the second wall portion 58B. Thus, disconnection of the common wire 55A due to the common wire 55A being caught between the pressing pin 18 and the insulator 52 can be prevented.

In the present embodiment, the jumper wire guide portions (the wall portions 59) configured to guide the jumper wires 55U, 55V, 55W connecting the coils 53 of the same phase are provided at the insulator 52, and therefore, the jumper wires 55U, 55V, 55W can be drawn in an appropriate path. Further, the pushed portion 60 pressed into the gap S1 between two wall portions 59 spaced apart in the circumferential direction is formed at each of the jumper wires 55U, 55V, 55W, and therefore, looseness of the jumper wires 55U, 55V, 55W can be suppressed. Thus, expansion of the jumper wires 55U, 55V, 55W to the outer peripheral side can be suppressed.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

1. A motor comprising:
a rotor; and
a stator arranged on an outer peripheral side of the rotor,
wherein the stator comprises a stator core, a plurality of insulators covering the stator core, a coil wound around the stator core through each of the insulators, and a common wire formed of a conductive wire drawn from the coil,
at least one of the plurality of insulators includes a first common wire support portion configured to support the common wire from an outside in a radial direction, and
the first common wire support portion extends inward in the radial direction toward a tip end side of the common wire.

2. The motor according to claim 1, wherein
the insulator provided with the first common wire support portion comprises a second common wire support portion connected to an end portion of the first common wire support portion, the end portion being on an inner side in the radial direction.

3. The motor according to claim 2, comprising:
a resin sealing member configured to cover the stator,
wherein the resin sealing member comprises a plurality of holes as arrangement marks of pressing members configured to press the stator against a mold for forming the resin sealing member, and
the second common wire support portion is arranged in an angular range including an angular position of any of the plurality of holes.

4. The motor according to claim 3, wherein
one insulator of the plurality of insulators is connected to a connector,
an insulator adjacent to the one insulator in a circumferential direction comprises a conductive wire guide portion configured to guide a conductive wire drawn from the coil to the connector, and
the conductive wire guide portion is arranged in an angular range including an angular position of any of the plurality of holes.

5. The motor according to claim 4, wherein
an insulator adjacent, in the circumferential direction, to the insulator provided with the first common wire support portion includes a common wire guide portion configured to guide the common wire.

6. The motor according to claim 5, wherein
the first common wire support portion is provided at a single location on each end side of the insulator in the circumferential direction.

7. The motor according to claim 1, wherein
each insulator of the plurality of insulators comprises a jumper wire guide portion configured to guide a jumper wire connecting the coils of an identical phase.

8. The motor according to claim 7, wherein
each insulator of the plurality of insulators comprises with the jumper wire guide portion at two locations spaced apart in the circumferential direction, and
the jumper wire comprises a pushed portion pushed into a gap between the jumper wire guide portions at the two locations.

9. A pump device comprising:
a motor comprising:
a rotor; and
a stator arranged on an outer peripheral side of the rotor,
wherein the stator comprises a stator core, a plurality of insulators covering the stator core, a coil wound around the stator core through each of the insulators, and a common wire formed of a conductive wire drawn from the coil,
at least one of the plurality of insulators includes a first common wire support portion configured to support the common wire from an outside in a radial direction, and
the first common wire support portion extends inward in the radial direction toward a tip end side of the common wire;
an impeller attached to a rotating shaft of the rotor; and
a pump chamber in which the impeller is arranged.

10. The motor according to claim 1, wherein
at least one of the insulators adjacent, in the circumferential direction, to the insulator provided with the first common wire support portion includes a common wire guide portion configured to guide the common wire.

11. The motor according to claim 1, wherein
the first common wire support portion is provided at a single location on each end side of the insulator in the circumferential direction.
